(19) United States
(12) Patent Application Publication
(10) Pub. No.: US 2023/0139751 A1
(43) Pub. Date: May 4, 2023

(54) CLUSTERING IN AUTOMOTIVE IMAGING

(71) Applicant: QUALCOMM Incorporated, San Diego, CA (US)

(72) Inventors: Amichai SANDEROVICH, Atlit (IL); Eran HOF, Haifa (IL); Olga RADOVSKY, Kiryat Bialik (IL)

(21) Appl. No.: 17/907,390

(22) PCT Filed: May 28, 2021
(86) PCT No.: PCT/US2021/034954

§ 371 Date: Sep. 26, 2022

(30) Foreign Application Priority Data
May 31, 2020 (IL) 275007

(51) Int. Cl. G06T 7/277; G06V 10/762; G01S 17/89; G01S 13/89; G01S 13/72; G01S 17/66

(52) U.S. Cl. CPC G06T 7/277; G06V 10/762; G01S 17/89; G01S 13/89; G01S 13/72; G01S 17/66; G06T 2207/10028; G06T 2207/30252

(57) ABSTRACT

In an imaging system comprising an imaging sensor generating successive point clouds from detected objects, tracking points of interest, or targets, across multiple point clouds/frames can be performed to enable robust object detection by clustering the targets based on one or more tracking parameters. An imaging sensor may comprise a radar sensor or lidar sensor, and tracking the one or more parameters of a target may be performed by a state model of the target.

### CROSS-REFERENCE TO RELATED APPLICATION

This application claims the benefit of priority from Israeli Provisional Application No. 275007, filed on May 31, 2020, which is hereby incorporated by reference in its entirety.

### BACKGROUND

### 1. Field of Invention

Aspects of the disclosure generally relate to the field of imaging radars, and more specifically to techniques for improving clustering of points, or targets, detected by an automotive imaging radar.

### 2. Description of Related Art

Various types of radar exist to detect and track objects. For example, a ping radar emits a ping signal and detects objects based on reflected signals. Some of the radars use frequency modulation, such as frequency-modulated continuous-wave (FMCW) radars. Additionally or alternatively, some of the radars use phase modulation, such as phase-coded microwave waveform (PCMW) radars. Other examples of radar that can be used include multiple-input multiple-output (MIMO) radar and synthetic-aperture radar (SAR). Additionally or alternatively, optical sensors can also be used for object detection and tracking. For example, a red green blue (RGB) image is generated and used to detect an object based on a pixel representation of the object in the RGB image. Given the pixel representations in multiple RGB images, the object is tracked.

In the automotive industry, imaging radars can also be used. A radar image is generated, typically at a lower resolution than an RGB image. Given the lower resolution, an object is detected and tracked across multiple radar images by using a relatively lower number of pixels. Radar systems, including imaging radars, can provide depth information and speed information while RGB imaging typically does not. lidar systems can provide similar imaging information.

### BRIEF SUMMARY

In an imaging system comprising an imaging sensor generating successive point clouds from detected objects, tracking points of interest, or targets, across multiple point clouds/frames can be performed to enable robust object detection by clustering the targets based on one or more tracking parameters. An imaging sensor may comprise a radar sensor or lidar sensor, and tracking the one or more parameters of a target may be performed by a state model of the target

An example method of clustering targets detected by an imaging sensor in support of object detection, according to this disclosure, comprises determining a target in a point cloud, wherein the point cloud is generated by the imaging sensor and corresponds to a sensor image. The method also comprises tracking one or more parameters of the target across a plurality of point clouds, wherein the one or more parameters are indicative of one or more characteristics of the target. The method also comprises including the target in a cluster of targets based on the tracking, wherein the cluster indicates a detected object.

An example device for clustering targets detected by an imaging sensor in support of object detection, according to this disclosure, comprises a memory, one or more processors communicatively coupled with the memory, wherein the one or more processors are configured to determine a target in a point cloud, wherein the point cloud is generated by the imaging sensor and corresponds to a sensor image. The one or more processing units are further configured to track one or more parameters of the target across a plurality of point clouds, wherein the one or more parameters are indicative of one or more characteristics of the target. The one or more processing units are further configured to include the target in a cluster of targets based on the tracking, wherein the cluster indicates a detected object.

An example apparatus for clustering targets detected by an imaging sensor in support of object detection, according to this disclosure, comprises means for determining a target in a point cloud, wherein the point cloud is generated by the imaging sensor and corresponds to a sensor image. The apparatus further comprises means for tracking one or more parameters of the target across a plurality of point clouds, wherein the one or more parameters are indicative of one or more characteristics of the target. The apparatus further comprises means for including the target in a cluster of targets based on the tracking, wherein the cluster indicates a detected object.

According to this disclosure, an example non-transitory computer-readable medium stores instructions for clustering targets detected by an imaging sensor in support of object detection, the instructions comprising code for determining a target in a point cloud, wherein the point cloud is generated by the imaging sensor and corresponds to a sensor image. The instructions further comprise code for tracking one or more parameters of the target across a plurality of point clouds, wherein the one or more parameters are indicative of one or more characteristics of the target. The instructions further comprise code for including the target in a cluster of targets based on the tracking, wherein the cluster indicates a detected object.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Aspects of the disclosure are illustrated by way of example. In the accompanying figures, like reference numbers indicate similar elements.

FIG. 1 is a block diagram of a radar system performing radar-based directional proximity sensing, according to an embodiment.

FIG. 2 illustrates an example of components of a radar system and a computer system, in accordance with at least one embodiment.

FIG. 3 illustrates an example of prior art clustering of targets from a point cloud, in accordance with at least one embodiment.

FIG. 4 illustrates an example of tracking targets from point clouds followed by a clustering of the targets based on the tracking, in accordance with at least one embodiment.

FIG. 5 illustrates an example of targets detected in a point cloud, in accordance with at least one embodiment.

FIG. 6 illustrates an example of tracking targets in point clouds in support of clustering and object detection, in accordance with at least one embodiment.

FIG. 7 illustrates an example of a flow for improving clustering in automotive imaging radars, in accordance with at least one embodiment.

FIG. 8 illustrates an example of an architecture of a computing device 800, according to embodiments of the present disclosure.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure.

As used herein, the term “target” may be used to refer to a tracked point of interest in a point cloud. As explained in further detail herein, targets may correspond to points in a point cloud obtained from a radar scan that exceed a threshold energy value and/or represent local peaks in energy values. Further, data obtained from each scan, or series of pulses used to obtain a point cloud for a volume of space, may be referred to herein as a radar “frame” or “image,” and may represent one or more dimensions of data obtained from the scan (e.g., azimuth, elevation, range, and/or Doppler/speed). The techniques provided herein may be applied to lidar, which can provide a similar “frame” or “image” output as radar.

Embodiments of the present disclosure are directed to, among other things, improving clustering in automotive imaging systems that produce point clouds, such as radars and lidars. In conventional systems, an imaging radar or lidar generates a point cloud, where an object may be sparsely represented with a small number of points (e.g., less than twenty points), and where this number is much smaller (e.g., 1/10 to 1/100 or less) than a pixel representation in an RGB image. The object can be detected by clustering the points together based, for example, on proximity of points in the point cloud. In contrast herein, the use of imaging radars/lidars and sparse representations of objects can be improved by tracking points over time. Again, tracked points may be referred to herein as targets. In particular, prior to clustering, targets may be tracked over time and parameters determined from the tracking may be used in the clustering. In particular, a target can be detected in a point cloud (e.g., a first frame) and tracked across multiple point clouds (or multiple successive frames). The tracking can involve one or more parameters, such as position, speed, acceleration, gain, time period during which the target is present in the point clouds, and/or rate of changes of such parameters.

By using a tracker prior to clustering in the manner described herein, various improvements to the performance of an imaging radar/lidar can be achieved. In particular, the clustering can be improved, where sparse objects can be clustered correctly, while disjoint dense clouds are separated well. Further, the clustering may not filter out weak (but consistent over time) targets. Robustness against clutter, false alarms, and flicker can also be achieved since such points are not consistent over time. In addition, point clouds with significantly less points can be used for correctly identify the objects. A simple implementation on a low-end digital signal processor (DSP) for better cost-performance becomes possible. The implementation can make effective use of massive parallel DSPs, such as the Qualcomm Q6-DSP with an Hexagon (HVX) coprocessor.

The following figures and description describe embodiments directed toward radar. However, embodiments are not so limited. As a person of ordinary skill in the art will appreciate, the techniques described herein may be applied to other imaging systems that produce a point cloud, such as lidar.

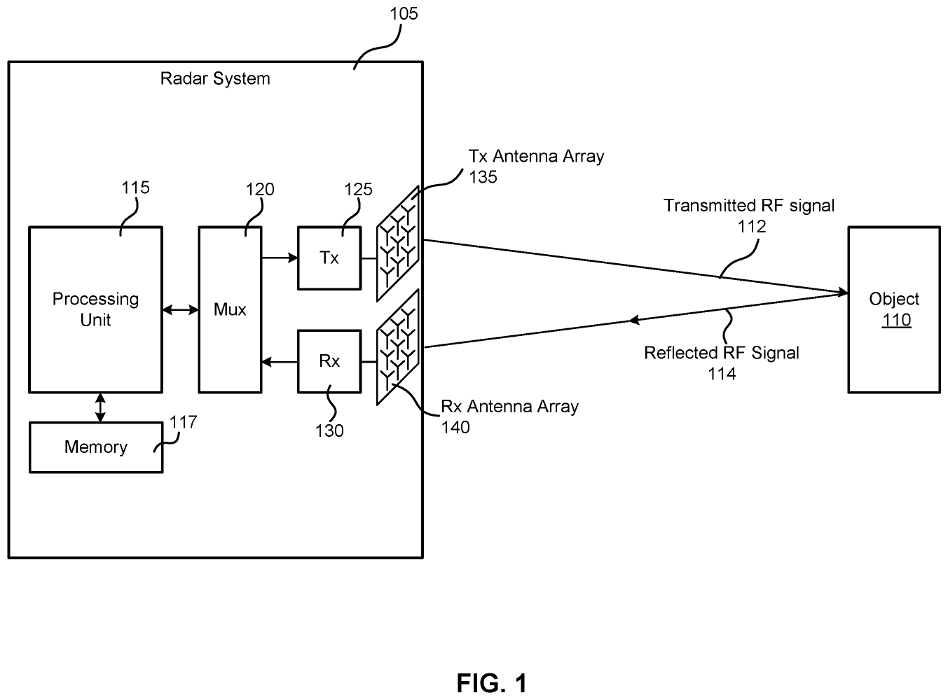

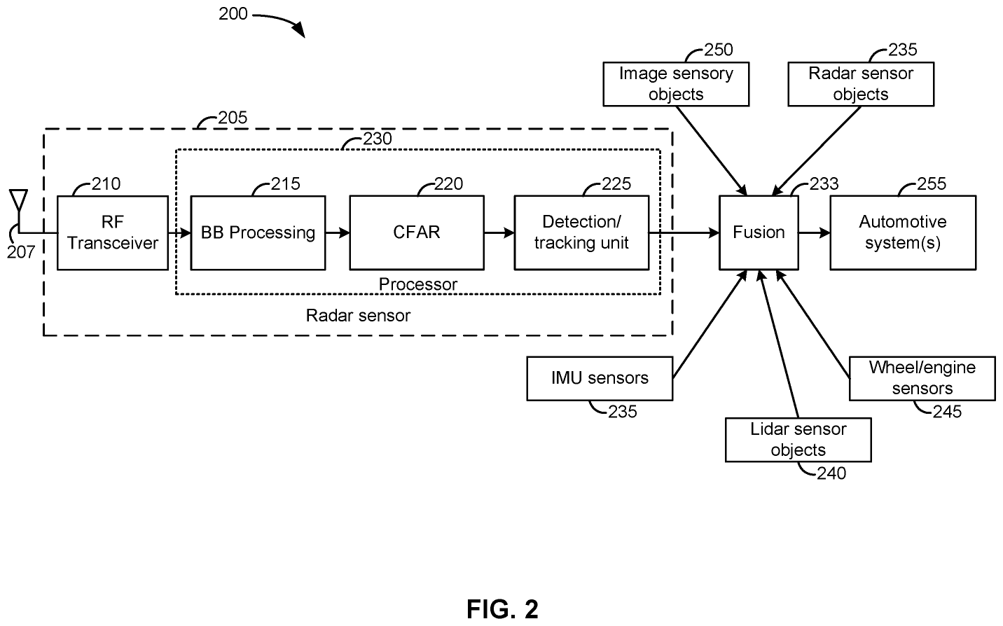

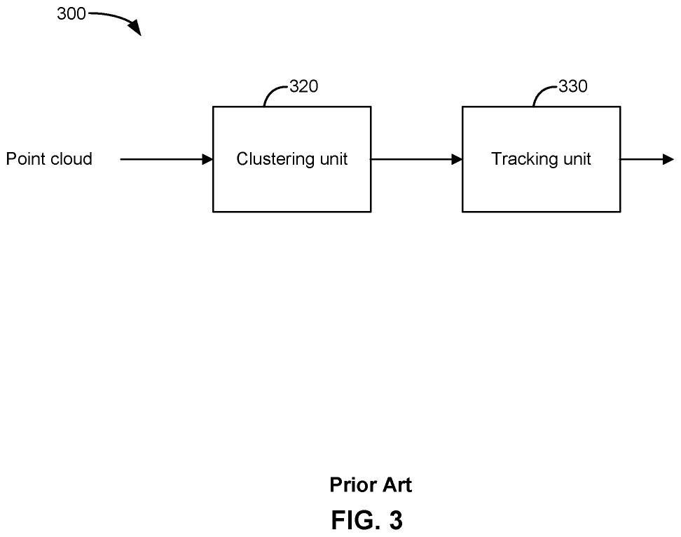

FIG. 1 is a block diagram of a radar system 105 that can be used to perform radar imaging in the manner described herein. As used herein, the terms “waveform” and “sequence” and derivatives thereof are used interchangeably to refer to radio frequency (RF) signals generated by a transmitter of the radar system 105 and received by a receiver of the radar system for object detection. A “pulse” and derivatives thereof are generally referred to herein as waveforms comprising a sequence or complementary pair of sequences transmitted and received to generate a channel impulse response (CIR). The radar system 105 may comprise a standalone device (e.g., a radar sensor) or may be integrated into a larger electronic device, such as a vehicle, as described in more detail with regard to FIG. 2. Additional details regarding radar system components and/or components of larger systems that may utilize a radar system 105 are provided hereafter with regard to FIGS. 3 and 9.

With regard to the functionality of the radar system 105 in FIG. 1, the radar system 105 can detect an object 110 by generating a series of transmitted RF signals 112 (comprising one or more pulses). Some of these transmitted RF signals 112 reflect off of the object 110, and these reflected RF signals 114 are then processed by the radar system 105. In particular, the radar system 105 may use beamforming (BF) and DSP techniques (including leakage cancellation) to determine the azimuth, elevation, velocity, and range of various reflected “points,” relative to the radar system 105, creating a point cloud in which the object 110 (and/or other objects) may be identified. As described in more detail below, points corresponding to different objects may have different values for azimuth, elevation, velocity, and range, and may be “clustered” to identify (and optionally tracked) different objects in the point cloud. According to some embodiments the radar system 105 may implement a flexible field of view (FOV), enabling the radar system 105 to scan and detect objects within a varying volume of space. This volume of space can be defined by a range of azimuths, elevations, and distances from the radar system 105. As noted, an object 110 identified in one point cloud or scan may be tracked in subsequent point clouds/scans.

Radar imaging provided by the radar system 105 may be enabled by a processing unit 115, memory 117, multiplexer (mux) 120, Tx processing circuitry 125, and Rx processing circuitry 130. (The radar system 105 may include additional components not illustrated, such as a power source, user interface, or electronic interface) It can be noted, however, that these components of the radar system 105 may be rearranged or otherwise altered in alternative embodiments, depending on desired functionality. Moreover, as used herein, the terms “transmit circuitry” or “Tx circuitry” refer to any circuitry utilized to create and/or transmit the transmitted RF signal 112. Likewise, the terms “receive circuitry” or “Rx circuitry” refer to any circuitry utilized to detect and/or process the reflected RF signal 114. As such, “transmit circuitry” and “receive circuitry” may not only comprise the Tx processing circuitry 125 and Rx processing circuitry 130 respectively but may also comprise the mux 120 and processing unit 115. In some embodiments, the processing unit may compose at least part of a modem and/or wireless communications interface. In some embodiments, more than one processing unit may be used to perform the functions of the processing unit 115 described herein.

The Tx processing circuitry 125 and Rx circuitry 130 may comprise subcomponents for respectively generating and detecting RF signals. As a person of ordinary skill in the art will appreciate, the Tx processing circuitry 125 may therefore include a pulse generator, digital-to-analog converter (DAC), a mixer (for up-mixing the signal to the transmit frequency), one or more amplifiers (for powering the transmission via Tx antenna array 135), etc. The Rx processing circuitry 130 may have similar hardware for processing a detected RF signal. In particular, the Rx processing circuitry 130 may comprise an amplifier (for amplifying a signal received via Rx antenna 140), a mixer for down-converting the received signal from the transmit frequency, an analog-to-digital converter (ADC) for digitizing the received signal, and a pulse correlator providing a matched filter for the pulse generated by the Tx processing circuitry 125. The Rx processing circuitry 130 may therefore use the correlator output as the CIR, which can be processed by the processing unit 115 (or other circuitry) for leakage cancellation as described herein. Other processing of the CIR may also be performed, such as object detecting, range, speed, or direction of arrival (DoA) estimation.

BF is further enabled by a Tx antenna array 135 and Rx antenna array 140. Each antenna array 135, 140 comprises a plurality of antenna elements. It can be noted that, although the antenna arrays 135, 140 of FIG. 1 include two-dimensional arrays, embodiments are not so limited. Arrays may simply include a plurality of antenna elements along a single dimension that provides for spatial cancellation between the Tx and Rx sides of the radar system 105. As a person of ordinary skill in the art will appreciate, the relative location of the Tx and Rx sides, in addition to various environmental factors can impact how spatial cancellation may be performed.

It can be noted that the properties of the transmitted RF signal 112 may vary, depending on the technologies utilized. Techniques provided herein can apply generally to “mmWave” technologies, which typically operate at 57-71 GHz, but may include frequencies ranging from 30-300 GHz. This includes, for example, frequencies utilized by the 802.11ad Wi-Fi standard (operating at 60 GHz). That said, some embodiments may utilize radar with frequencies outside this range. For example, in some embodiments, 5G frequency bands (e.g., 28 GHz) may be used. Because radar may be performed in the same busy bands as communication, hardware may be utilized for both communication and radar sensing, as previously noted. For example, one or more of the components of the radar system 105 shown in FIG. 1 may be included in a wireless modem (e.g., Wi-Fi or 5G modem). Additionally, techniques may apply to RF signals comprising any of a variety of pulse types, including compressed pulses (e.g., comprising Chirp, Golay, Barker, or Ipatov sequences) may be utilized. That said, embodiments are not limited to such frequencies and/or pulse types. Additionally, because the radar system may be capable of sending RF signals for communication (e.g., using 802.11 communication technology), embodiments may leverage channel estimation used in communication for performing radar imaging as provided herein. Accordingly, the pulses may be the same as those used for channel estimation in communication.

Depending on desired functionality, the radar system 105 can be used as a sensor for object detection and tracking. This can be particularly helpful in many applications, such as vehicular applications. In such applications, the radar system 105 may be one of many types of sensors used by the vehicle to provide various types of functionality.

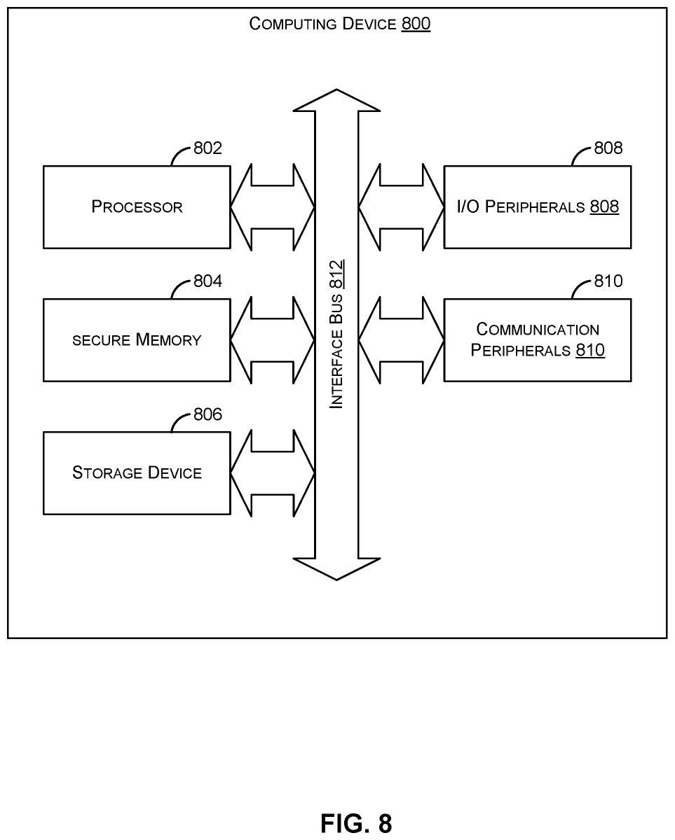

For example, according to some embodiments, a vehicle may comprise a radar system 105 communicatively coupled with a computer system. Example components of a computer system are illustrated in FIG. 8, which is described in further detail hereafter. According to some embodiments, the vehicle may be autonomous, semi-autonomous, or manually operated. Additionally or alternatively, the radar system 105, and/or a complete or partial combination of the radar system 105 with a computer system, may be installed in a number of other suitable devices or systems, such as in a road-side unit (RSU). If employed in a vehicle, the radar system 105 can be used, with a computer system, to obtain imaging radar to detect, track, and/or classify stationary and moving objects around the vehicle while the vehicle is parked or is in motion. As noted, an object 110 may be detected from one or more point clouds obtained by the radar system 105 by detecting and tracking targets corresponding to the object 110 in the point clouds and clustering these targets based on the tracking.

According to some embodiments, an output of the radar system 105 may be sent to a computer system (e.g., an onboard computer of a vehicle). The output can indicate the detected objects and, optionally, a classification of these objects and their tracking over time. According to some embodiments, the computer system may receive the information and perform one or more vehicle management or control operations based on the information and, optionally, information from other systems (e.g., other sensors) of the vehicle. The vehicle management or control operations can include, for instance, autonomous navigation, obstacle avoidance, alerts, driver assistance, and the like.

FIG. 2 is a block diagram illustrating an automotive system 200, illustrating how a radar sensor 205 may be used in an automotive application, in accordance with at least one embodiment. Here, the radar sensor 205 may correspond with the radar system 105 of FIG. 1. Components of the radar system 205 and radar system 105 also may correspond with each other, as indicated below.

In this example, the radar sensor 205 includes an antenna 207, a radio frequency (RF) transceiver 210, and a processor 230. According to some embodiments, the antenna may comprise an antenna array to enable directional transmission and reception of RF signals, as described in relation to FIG. 1. As such, the antenna 207 may correspond with TX antenna array 135 and/or Rx antenna array 140 of FIG. 1. Further, the RF transceiver 210 may comprise RF front-end components (e.g., circuitry) used for transmitting and receiving pulses (e.g., in the manner described with regard to FIG. 1), and interfacing with digital baseband processing. As such, RF transceiver 210 may correspond with Tx processing circuitry 125, Rx processing circuitry 130, and/or mux 120 of FIG. 1.

The processor 230 may comprise a DSP or other processor used for signal processing, and may therefore correspond with processing unit 115 of FIG. 1. The processor 230 may include, among other components, a baseband (BB) processing unit 215, which may perform analog processing and/or fast Fourier transform (FFT) processing to output digital data that includes points. This data may be uncompressed and therefore may include, for example, a row report comprising energy values for all points in a scan (e.g., points for all azimuth, elevation, range, and/or Doppler/speed). The processor 230 can also include a constant false alarm rate (CFAR) unit 220 that may compress data received from the BB processing 215 unit and output a point cloud. (Alternative embodiments may perform additional or alternative data compression in a similar manner.) As previously noted, a point cloud may comprise a set of data points (e.g., energy values) in a multi-dimensional space corresponding to a single scan/frame (e.g., two-dimensional (2D) space for azimuth and range, speed and arrange, etc.; three-dimensional (3D) space for range, speed, and azimuth measurements; four-dimensional (4D) space for range, speed, azimuth, and elevation; five-dimensional (5D) space for range, speed, azimuth, elevation, and reception signal to noise ratio (SNR)). Further, the processor 230 may include a detection/tracking unit 225 that detects and, optionally, tracks and classifies objects from the point clouds output by the CFAR unit 220. According to some embodiments, the detection/tracking unit 225 may comprise a DSP that can support single instruction, multiple data (SIMD) operations and can be, for instance, a Qualcomm Q6-DSP with an HVX coprocessor. As described in further detail below, object detection, according to some embodiments, may involve tracking targets across multiple point clouds/frames and clustering targets that have similar tracking parameters. According to some embodiments, each cluster can include one or more targets that have been tracked in multiple point clouds/successive frames. Further, because each cluster can correspond with a detected object, each cluster can be used to identify and track different objects.

It can be noted that the processor 230 and/or radar sensor 205 may perform processing operations that may not be shown in FIG. 2. This can include, for example, performing super-resolution techniques on radar data. Super-resolution techniques can include any technique that can be used to improve the resolution of one or more dimensions of data obtained by a radar system beyond the native resolution. This can include, for example, auto-correlation, Multiple Signal Classification (MUSIC), Estimation of Signal Parameters via Rational Invariance Techniques (ESPRIT), and/or other such techniques. The techniques herein for clustering in automotive imaging radar, described in more detail hereafter, may be used in conjunction with such super-resolution techniques.

The other components of the automotive system 200 may be executed by, integrated into, or communicatively coupled with an automotive computer system, which may be located at one or more positions on a vehicle. Further, an automotive computer system may include one or more of the components illustrated in FIG. 8. The other components of the automotive system 200 may comprise a sensor fusion unit 233 that implements a sensor fusion algorithm to combine sensor data received as input from multiple sensors. The sensor data can include output from the radar sensor 205 (e.g. output from the detection/tracking unit 225). Other sensor data can be available from, for instance, one or more additional radars (which may include additional imaging radars), inertial measurement unit (IMU) sensors 235, LIDAR sensor(s) 240, wheel sensor(s), engine sensor(s) 245, image sensors (e.g., cameras) 250, and/or other types of sensors. In addition, the automotive system 200 may include one or more automotive systems 255 that may implement autonomous and/or semi-autonomous functionality based on input from the sensor fusion unit 233. The automotive system(s) 255 may comprise autonomous driving decision unit, an advanced driver-assistance system (ADAS), or other components that manage and/or control operations of a vehicle.

FIG. 3 is a block diagram that illustrates example operations 300 of for performing clustering of points from a point cloud in traditional imaging radar. This functionality may be performed, for example, by a processor 230 of a radar sensor 205. As illustrated, a point cloud, which includes multiple data points, is input to a clustering unit 320 that groups the data points into clusters. As a person of ordinary skill in the art will appreciate, the clustering unit 320 may implement any of a wide variety of clustering algorithms. Density-Based Spatial Clustering of Applications with Noise (DBSCAN) as an example of a common clustering algorithm that may be implemented by the clustering unit 320.

Depending on desired functionality, the clustering unit 320 may further remove clusters with a small number of data points. Each of the remaining clusters can correspond with a detected object. To classify and track the object, information about each of the remaining clusters (e.g., number, positions, distributions, and density of the data points, and the like) may be provided by the clustering unit 320 to a tracking unit 330, which tracks the objects over time. According to some embodiments, the tracking unit 330 may include a classifier. The classifier, which can be implemented as a neural network (e.g., a recurrent neural network (RNN)) classifies the objects into object types (e.g., vehicles, pedestrians, road signage, etc.).

A clustering unit 320 can be configured to track point clouds across several frames. However, doing so on existing conventional systems is problematic for many reasons. For example, the computational load is significantly large due to very large number of data points, thereby creating an implementation issue on DSPs (e.g., processor 230) used to perform the functionality illustrated in FIG. 3. In addition, the clustering accuracy can be degraded because many of the data points can be filtered out and dismissed (e.g., incorrectly not being added to clusters), especially in situations of interfering objects. As further described herein below, embodiments of the present disclosure overcome such obstacles.

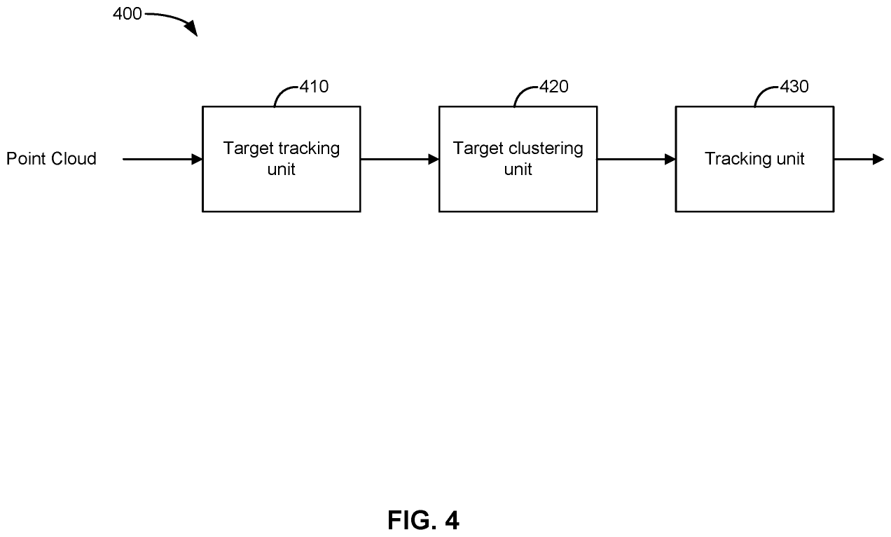

As noted, embodiments herein may address these and other issues by tracking points of interest, or targets, over multiple point clouds/frames. Further, clustering can be based on one or more tracking parameters, thereby obviating the need for traditional clustering algorithms, according to some embodiments. Additional details are provided below with regard to FIG. 4.

FIG. 4 is a block diagram that illustrates example operations 400 for improved clustering, in accordance with at least one embodiment. Similar to the operations 300 illustrated in FIG. 3, the operations 400 of FIG. 4 can be performed on a processor, such as the processor 230 of FIG. 2 described above. As illustrated, a point cloud from a frame is input to a target tracking unit 410, which detects targets in the point clouds and tracks the targets across different point clouds from successive frames to form tracking hypotheses. This tracking algorithm may maintain likelihoods and/or probability measures for how certain the various tract trajectories/hypotheses are. The output of the tracker is sent to a target clustering unit 420 that then clusters the tracking hypotheses based on one or more tracking parameters, as described in further detail below. Each of the clusters may correspond with a detected object. And thus, information about the clusters may be provided by the target clustering unit 420 to a tracking unit 430 that tracks the clusters/objects over time. Similar to the tracking unit 330 of FIG. 3, the tracking unit for 30 of FIG. 4 may optionally include a classifier that classifies the objects into object types.

In an example, the point cloud includes multiple data points generated by an imaging radar from a radar image (frame) that the imaging radar generates at a particular frame rate. Filtering can be applied to remove some data points. According to some embodiments, such filtering may be based on energy level, such as gain. The threshold energy level used for filtering may vary, depending on desired functionality. Additionally or alternatively, filtering may be based on peaks. That is, values are filtered out unless they represent a peak in the data, where all neighboring values are lower. According to some embodiments, a data point can be filtered out if it is too far from targets from previous frames and/or from an expected trajectory). Remaining data points after filtering are targets.

According to some embodiments, a target included in a point cloud can have one or more tracking parameters that relate to a trajectory that the target follows over the course of multiple frames. The trajectory can correspond to a motion of the target relative to the imaging radar (e.g., the target is in motion), a motion of the imaging radar relative to the target (e.g., the target is stationary), or the target and the imaging radar having separate motions. Even when the target is stationary relative to the imaging radar, if the target persistently appears in the point clouds (e.g., as indicated by the values of its parameters), the target also may be tracked. Examples of the parameters include a Cartesian position in 3D space (e.g., x, y, z coordinates), a polarization position in 3D space (e.g., range, azimuth, elevation), a polarization type, and a radial speed (e.g., Doppler) and energy (e.g., gain). Optimally, each target in the point cloud has a same set of trackable parameters. However, in reality and depending on conditions (e.g., environmental conditions and noise conditions, etc.), some of the parameters may not be tracked for a subset of the targets (e.g., for one target, all the parameters may be measured, whereas for another target, the radial speed may not be determined).

The target tracking unit 410 can track targets in each of the point clouds and over time (e.g., across different frames). Generally, for each target, the tracker maintains a state model (e.g., a Kalman filter) that stores the measured values of the parameters. The state model can be maintained over time, such as at a same frame as the radar fames, and can show, at each point in time (e.g., at each frame), the values of the parameters. In an example, the state model is stored in a state memory, whereby only a subset of the data is retained (e.g., the last ten frames) and new data replaces the oldest data (e.g., the values corresponding to the current frame replaces the values stored in association with the oldest tenth frame). In addition, the state model can store a time duration during which the target is tracked (e.g., as a function of a start time and end time or as a function of the number of frames in which the target is present). Further, for each of the targets and for each parameter of the target, the tracker can generate and store, in the corresponding state model, a number of derivatives (e.g., a first derivative, a second derivative, and so on), where the tracker determines these derivatives from the values tracked for the parameters (e.g., a rate of change for a parameter or an acceleration for the radial speed, etc.). Furthermore, the tracker can store in a target's state model statistical data related to the parameters, derivatives, or behavior of the target. Statistical data can include any statistical measure, such as media, average, variance, maximum, etc. Statistical data can also include noise or stochastic analysis data and projections.

From the state models of the different targets, the tracker can form tracking hypotheses. In an example, a tracking hypothesis indicates that a target is tracked across multiple point clouds (e.g., across multiple radar frames), where the target has a trajectory, or where the target is stationary (while the imaging radar is also stationary) and is persistently tracked. A target that does not meet these criteria (e.g., appears in one point cloud and disappears otherwise) does not have a tracking hypothesis and can be removed.

The removal of targets that do not have tracking hypotheses in this manner can provide a number of advantages. In traditional clustering, for example, flickering may occur when different areas of an object provide targets in different frames. For example, for an object comprising a car, a few frames may include targets corresponding to reflections from the wheels, then other frames include targets corresponding to a car door. So traditional clustering may not include all these targets together may decide that these are two different objects. However, the removal of targets that appear in only one point cloud, as utilized by the embodiments disclosed herein, provides a natural robustness against clutter, false alarms, and flicker. As a result, the clustering of targets in this manner and subsequent classification of clustered targets may utilize far fewer processing resources than traditional clustering and classification algorithms.

For targets that have a tracking hypothesis, some or all of the parameters tracked in the corresponding state model may be provided by the target tracking unit 410 to the target clustering unit 420. In other words, the target clustering unit 420 receives multiple inputs, and each input corresponds to a target that has a tracking hypothesis and includes the values of the applicable parameters.

The target clustering unit 420 may implement a clustering algorithm (e.g., a DBSCAN algorithm) that generates clusters of targets based on the inputs, where the inputs can be chosen from an arbitrary space. This space may include one or more different parameters used for clustering, depending on desired functionality. For example, an application that analyzes radial speed, the input parameters may relate to the radial speed. Each cluster determined by the target clustering unit 420 may correspond with a detected object. In an example, the target clustering unit 420 may implement a clustering algorithm that uses a similarity (e.g., a function that measures how similar multiple elements are, such as a threshold (e.g., E distance)) to cluster the targets together. In particular, two or more clusters that have similar parameters (where this similarity is determined by comparing the values of the parameters to determine differences and comparing the differences to the E distance) may be added to the same cluster. A target that is not similar to any other cluster may still be retained and added to a cluster that includes this target only.

Given that each target can have a number of parameters, different techniques to determine similarities are possible. In one example technique, for two or more targets, if the values of the same type of parameter are similar (e.g., within a threshold from each other), these targets are found to be similar and clustered together (e.g., if their positions are within the threshold relative to each other, the targets are added to the same cluster regardless of the similarities of the other parameters). In another example technique, the values have to be similar for each parameter type (e.g., their positions being within the threshold may not be sufficient to cluster the targets; instead, the radial speeds need to be also similar, and so on). In yet another example technique, a weighted sum is used. In particular, the difference between the values of each parameter type is determined (e.g., the position difference and the radial speed difference, etc.). Each difference is allocated (e.g., multiplied by) a weight specific to the corresponding parameter (e.g., the position may be weighed more than the radial speed but less than the gain). If the weighted sum of the values across the different parameters is less than a threshold, the corresponding targets are included in the same cluster.

Although the tracking may be operated at a first frame rate (e.g., the same frame rate at which the radar images are generated), the clustering unit 420 can perform clustering at the same frame rate or at a different frame rate. For instance, the clustering can occur at five-frame intervals, rather than at each frame. In addition, whereas the tracking may involve a number of frames (e.g., the last ten point clouds), the clustering algorithm may involve the same or a different number of frames (e.g., the last five point clouds).

Once the target clustering unit 420 clusters the targets, (the tracking unit 430 may then track the objects over time, where each cluster corresponds to an object. According to some embodiments, the tracking unit 430 may derive the parameters for tracking the object from the parameters of the target(s) that are included in the corresponding cluster. For example, the value of each parameter type of the object can be a median, maximum, minimum, average, etc. of the values of the same parameter type of the target(s). As a specific example, the radial speed of the object can be derived from the average radial speed of the targets.

As previously noted, the tracking unit 430 may optionally include a classifier, such as an RNN, which can classify the objects. The classification may also use the parameters of the targets that correspond to each object and/or the tracked parameters of each object.

Different possible types of trackers and cluster algorithms are possible. Examples of the possible trackers and cluster algorithms and the used parameters are summarized in Table 1 below.

TABLE 1

| | | Dynamic Model | | |
|---|---|---|---|---|
| | | (DM) | Measurement | |
| Tracker | Tracker | Target State | Model | Input parameters |
| Model | name | (TS) | (MM) | to cluster algorithm |
| Linear | Alpha-Beta- | Cartesian CS | Cartesian CS | target state |
| Trackers | Gamma | Target State: | Measurements | memory is CTS and |
| (linear | | For e.g. CV, CA, | can consist of | can consist of [x, y, |
| DM and | | CT, Jerk models | position | z, Doppler, Gain, vx, |
| MM) | | CTS can consist of: | velocity | v_{y}, v_{z}, V_Doppler, |
| | | position (x, y, z) | acceleration | V_gain, ax, a_{y}, a_{z} |
| | | velocity (vx, v_{y}, v_{z}) | Polar CS | a_Doppler, a_gain] |
| | | acceleration (ax, a_{y}, a_{z}) | Measurements | Cartesian |
| | | Polar CS Target | can consist of | measurement and |
| | | State: | range | can consist of [x, y, |
| | | PTS can consist of | azimuth | z, vx, v_{y}, v_{z}, ax, a_{y}, a_{z}] |
| | Kalman | range (r) | elevation | target state |
| | | azimuth (θ) | Doppler | memory is CTS |
| | | elevation (φ) | Peak | measurement: can |
| | | doppler (d) | measurements | be cartesian |
| | | Fused Target | | [x, y, z, vx, v_{y}, v_{z}, |
| | | State: | | ax, a_{y}, a_{z}] or can be |
| | | constructed from | | polar [r, θ, φ, d] |
| | | CTS and PTS or | | prior state error |
| | | other parameters, | | covariance matrix |
| | | e.g. gain (g) | | innovation memory |
| Non- | Unscented | | | target state |
| Linear | Kalman | | | memory generally |
| Trackers | Extended | | | can consist of the |
| DM | Kalman | | | following |
| and/or | Converted | | | parameters |
| MM can | measurements | | | [x, y, z, vx, v_{y}, v_{z}, ax, |
| be | Kalman | | | a_{y}, a_{z}, r, θ, φ, d, g] |
| nonlinear | Adaptive | | | polar |
| | Kalman | | | measurements and |
| | Particle | | | can consist of |
| | Filter | | | [r, θ, φ, d, g] |
| | | | | innovation memory |
| | | | | prior state error |
| | | | | covariance matrix |

In the above Table 1, a Cartesian target state can be defined in any of x, y and z directions; a state memory is associated with stored previously estimated state values, for example, from one to ten frames; Cartesian measurements measured at the time that estimation of the state is performed; and an innovation memory is associated stored previously calculated innovation values to verify that tracking is consistent, for example, from one to ten frames.

Further, in Table 1, the following notations are used:
CS—Coordinate space
CV—Constant Velocity
CT—Constant Turn
CA—Constant Acceleration
DM—Dynamic Model
PM—Polar Measurement
TS—Target state
CTS—Target State in Cartesian coordinates
PTS—Target State in Polar Coordinates

In an Alpha-Beta-Gamma (α-β-γ) filter, a target state is estimated using constant gains alpha, beta and gamma gains; an error covariance matrix is not used. In a Kalman filter, a target state is estimated by calculating Kalman gain and error covariance matrix. In an unscented Kalman filter, an approximate nonlinear model (mean and covariance) is used by set of points that captures the posterior mean and covariance accurately to the third order (Taylor series expansion) for any nonlinearity. The target state is estimated by using the normal Kalman filter equations. In an extended Kalman filter, an approximate nonlinear model by the linear model uses first order of Taylor expansion (Jacobean matrix). The target state is estimated by using the normal Kalman filter equations. In a converted measurements Kalman, polar measurements are converted to Cartesian coordinates. The target state is estimated by using the normal Kalman filter equations. In an Adaptive Kalman filter, multiple Gaussian filters are used. System dynamics can switch between multiple DM (CV, CA, and CT for example). A particle filter samples the uncertainty distribution using weighted particles.

In an example, Cartesian coordinates and/or polarization coordinates that are output by a simple α-β-γ filter are input (shown herein next as “ClusterINParams) to a clustering algorithm. In the case of Cartesian coordinates, the inputs are ClusterInParams: [x,y,z,Doppler,Gain, V_x, V_y, V_z, V_Doppler, V_Gain, a_x, a_y, a_z, a_Doppler, a_gain, LivingTime]. In the case of polarization coordinates, the inputs are ClusterInParams: [range,azimuth,elevation,Doppler,Gain, V_range, V_azimuth, V_elevation, V_Doppler, V_Gain, a_range, a_azimuth, a_elevation, a_Doppler, a_gain, LivingTime]. The Cartesian coordinates and polarization coordinates can be combined. the case of combined coordinates, the inputs ClusterInParams: [x,y,z,range,azimuth,elevation,Doppler,Gain,, . . . ]. [x,y,z] or [range,azimuth, elevation] are the position of the point in 3D. Doppler is the radial speed as measured by the Doppler frequency offset. Gain is the gain in which the point is being received. V_parameter is the estimated changes in the measurement per frame. a_parameter is the estimated rates of change (e.g., accelerations) in the measurements per frame.

The above examples are provided for illustrative purposes only. A partial subset of any of these parameters can be used instead. In addition, only the measurements and the corresponding changes can be used. Additionally or alternatively, the input parameters (e.g., ClusterInParams) from the last number “K of frames may be used.

For a Kalman filter, the ClusterInParams can include the same parameters as the ones from the α-β-γ. In addition, these inputs can include [I_x,I_y_I_z,I_Doppler,I_gain] and [P_x,P_y,P_z,P_Doppler,P_gain]. I stands for the innovation as defined by the Kalman equations. P stands for the covariance matrix of the post-estimation as defined by the Kalman filter.

For an unscented Kalman filter, the ClusterInParams can include the same parameters as the ones from the Kalman filter, and in addition, the set of points that represents the posterior mean and covariance of x,y,z.

For particle filter tracker, the ClusterInParams can include the parameters from the Kalman filter, and in addition, the uncertainty distribution using weighted particles of the parameters, like PDF_x.

It further can be noted that, depending on desired functionality, one or more machine learning algorithms and/or neural networks may be utilized to perform tracking and/or clustering. This may be in addition or as an alternative to the tracking and/or clustering techniques described above with regard to Table 1.

Although not illustrated in FIG. 4, an assignment module may be used. This module may be integrated with the tracking unit 430 or may be a standalone module that interfaces with the tracking unit 430. In both examples, the assignment module may be used to determine targets from data points and assign such targets to the tracker for tracking. The assignment module may use different parameters to determine whether a data point is to be set as a target or not. Some of the parameters are derivable from a current frame. For instance, a threshold can be set for the gain. If a gain of a data point in a current point cloud is larger than the threshold, the data point is assigned as a target. Otherwise, the data point may not be assigned as a target. Other parameters are derivable from multiple frames. For instance, if a data point persists for a minimum amount of time (e.g., is present in a minimum number of consecutive point clouds), the data point is assigned as a target. Otherwise, the data point may not be assigned as a target. Of course, current and multiple frame parameters can be used in conjunction. Referring back to the illustrated parameters, if a data point has a gain larger than the threshold, the data point is set as a target. Otherwise, if the data point persists for the minimum amount of time, the data point is still assigned as a target. Otherwise (e.g., gain below threshold and persistence less than minimum amount of time), the data point is not assigned as a target.

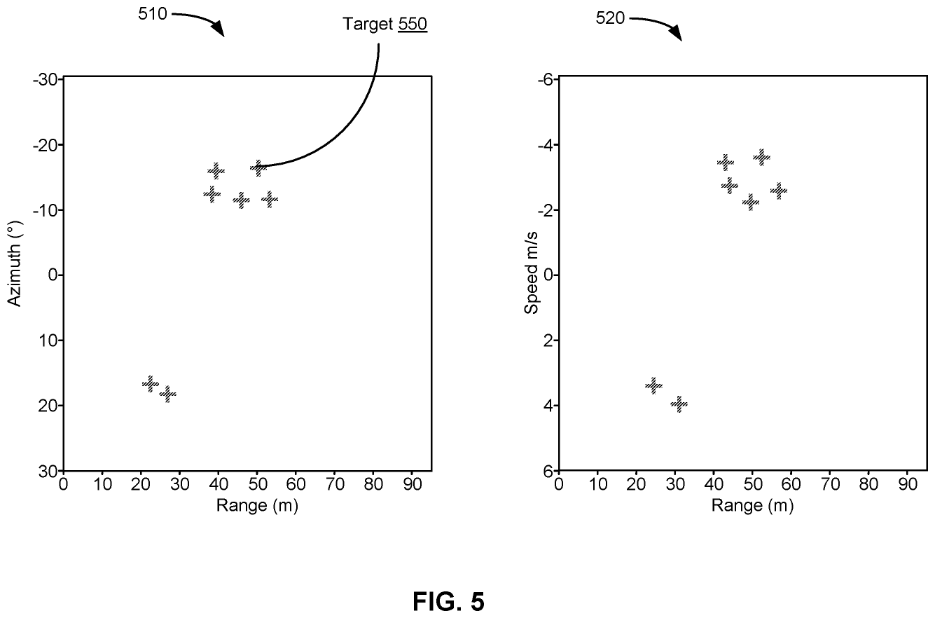

FIG. 5 includes two plots 510 and 520 of example targets 550 detected in a point cloud, in accordance with at least one embodiment. The two plots 510 and 520 may be derived from the same point cloud. In particular, the point cloud is generated by a radar sensor (e.g., radar sensor 205 or radar system 105) and, after filtering points coring responding to values below a threshold energy and/or non-peak values as previously described, includes multiple targets, each of which has a number of parameters. The first plot 510 shows the azimuth of the targets as a function of the range (the targets are illustrated with a “+” sign and one of them labeled with element 550). The second plot 520 shows the speed (e.g., radial) as a function of the range. Other plots are possible, in which each may correspond to one or more measured or derivative parameters of the targets. As previously noted, according to some embodiments, the targets 550 may first be tracked prior to clustering.

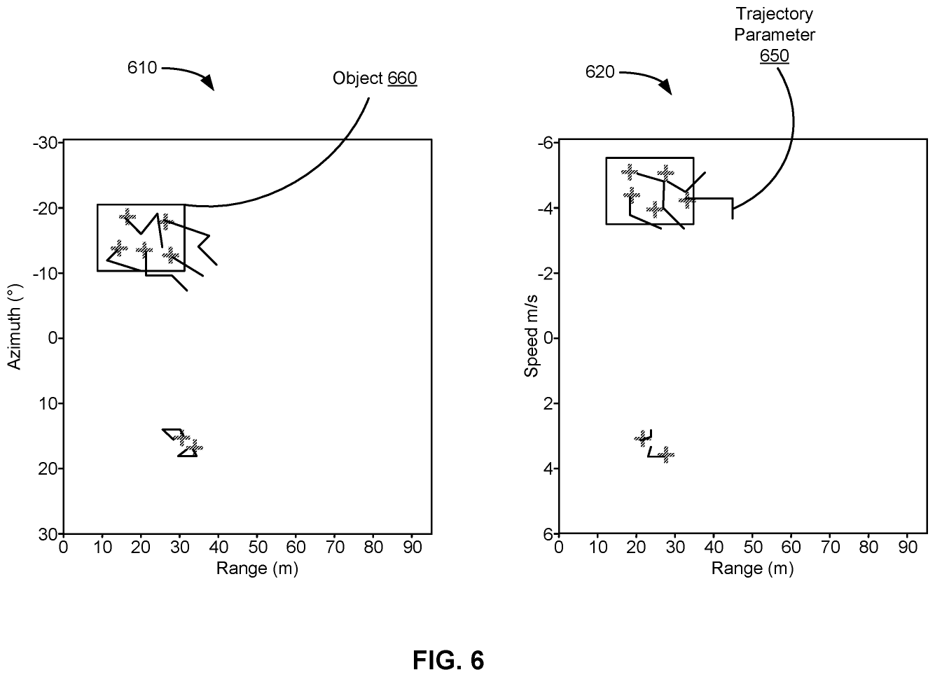

FIG. 6 includes two plots 610 and 620 illustrating an example of tracking targets in point clouds in support of clustering and object detection, in accordance with at least one embodiment. Here, the two plots 610 and 620 correspond to changes to plots 510 and 520, respectively, over time. In particular, the first plot 610 shows the azimuth of the targets as a function of the range (the targets are illustrated with a “+” sign). The second plot 620 shows the speed as a function of the range.

Each of the shown parameters (e.g., azimuth and speed) is tracked over time (e.g., across different point clouds, each corresponding to a different radar frame). The tracking is illustrated in the plot with lines, one of the lines is labeled with element 650 and indicates a trajectory (expressed with speed as function of range) over time.

Because the upper left targets have similar parameters (e.g. similar azimuths and similar speeds, as shown with the similar trajectories in the two plots 610 and 620), these targets are included in a same cluster. The cluster corresponds to an object 660 (illustrated with a bounding box around the targets). As indicated elsewhere herein, the object 660 may be tracked and/or classified using the same band/or different parameters.

Similarly, the lower left targets have similar properties and these properties are different from the properties of the upper left targets. Accordingly, the lower left targets can be clustered together.

As indicated elsewhere herein, secondary or derivative parameters may also be used for purposes of clustering. That is, in addition or as an alternative to speed and/or azimuth as parameters for clustering targets for purposes of tracking an object 660, a state model used to track each trajectory parameter 650 may additionally or alternatively track derivative parameters such as acceleration (e.g., the slope of trajectory parameters 650 in plot 620) and/or velocity (e.g., the slope of the trajectory parameters in plot 610).

Although not illustrated in FIGS. 5-6, if a target (or a collection of targets that are near each other) persisted in the different point clouds but did not have a detectable trajectory, if any, the target(s) belongs to a cluster that represents an object.

Again, the techniques described herein for tracking and clustering may apply to imaging systems that use additional or alternative sensors for producing a point cloud. This can include, for example, and imaging system comprising one or more lidar sensors.

As a person of ordinary skill in the art will appreciate, different sensors may produce point clouds comprising different data. lidar, for instance, may not provide Doppler, but may still provide and intensity value for each azimuth, elevation, and/or range.

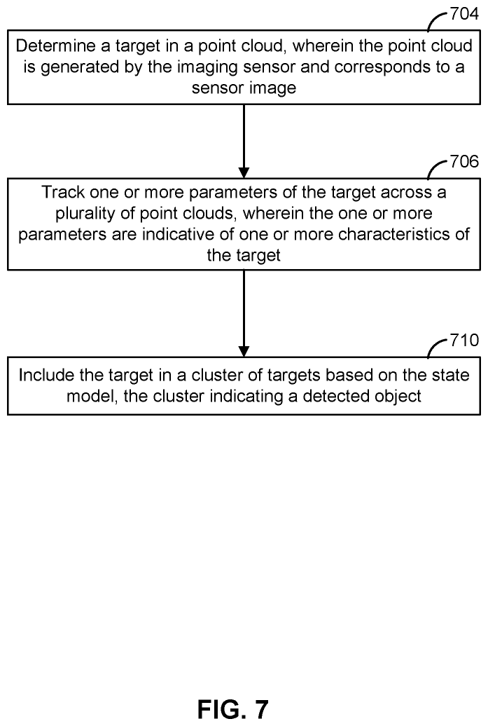

FIG. 7 is a flow diagram illustrating a method for clustering targets detected by an imaging sensor in support of object detection, in accordance with at least one embodiment. Some or all of the instructions for performing the operations of the illustrative flows can be implemented as hardware circuitry and/or stored as computer-readable instructions on a non-transitory computer-readable medium of a device, such as an imaging radar that includes a processor as described herein above in connection with FIGS. 1-2 (e.g., processing unit 115, and/or processor 230) and/or an imaging lidar, which may have similar hardware components. As implemented, the instructions represent modules that include circuitry or code executable by a processor(s) of the device. The use of such instructions configures the device to perform the specific operations described herein. Each circuitry or code in combination with the processor represents a means for performing a respective operation(s). While the operations are illustrated in a particular order, it should be understood that no particular order is necessary and according to alternative embodiments, one or more operations may be omitted, skipped, performed in parallel, and/or reordered.

In an example, the flow includes operation 704, where the device determines a target in a point cloud, wherein the point cloud is generated by an imaging sensor and corresponds to a sensor image. As described previously, the sensor image (or frame) may indicate energy values for one or more dimensions (e.g., azimuth, elevation, range, Doppler), indicative of reflections of objects at different points along the one or more dimensions. For instance, the point cloud may be derived from the sensor image to include sparse data points where each data point is associated with a set of parameters. As also noted, techniques herein may be used in conjunction with super-resolution techniques. As such, according to some embodiments, the imaging rater may further perform one or more super resolution techniques on sensor data to generate the point cloud. Again, this can include performing auto-correlation, MUSIC, ESPRIT, and/or other such techniques.

Determining the target in the point cloud may comprise determining to track a data point in the point cloud based on a parameter of the data point in the point cloud, a parameter of the data point across multiple point clouds, or both, wherein the data point corresponds to the target. As described previously, the point cloud may be filtered to exclude data points, and any remaining data points may be considered targets. For instance, a target may be determined as a data point for which one or more conditions are met (e.g., its gain or energy is larger than a threshold, it comprises a local peak, it has persisted in more than one point cloud, at least a subset of its parameters can be measured, etc.). Determining the target may also include measuring its parameters and/or deriving other parameters from the measurements. The measured and/or derived values may be stored in a state model associated with the target. This operation may be repeated for the various targets in the point cloud.

At operation 706, the device tracks one or more parameters of the target across a plurality of point clouds, wherein the one or more parameters are indicative of one or more characteristics of the target. (These characteristics may be derived from parameters and/or may be parameters themselves.) For example, the parameters may be indicative of a location of the target relative to the imaging sensor. Over time, these parameters may indicate movement (or lack thereof), relative to the imaging sensor. As explained above, a target may remain stationary in the point clouds and its parameters may indicate so. The tracking can include measuring each of the parameters in the various point clouds and deriving the other parameters as applicable. This operation may be repeated for the various targets in the point cloud.

according to some embodiments, tracking one or more parameters of the target may comprise updating a state model of the target. In such embodiments, the state model may comprise the one or more parameters (such as the ones that are measured and the ones that are derived). The updating can include storing the value for each parameter as a function of time (e.g. time “t1,” time “t2,” etc.) or a function of a frame (e.g., frame “1”, frame “2,” etc.). This operation may be repeated for the various targets in the point cloud.

At operation 710, the device includes the target in a cluster of targets based on the state model, the cluster indicating a detected object. For instance, as previously described with regard to FIG. 4, the some or all the parameters from the state model of the target (which may be maintained by a target tracking unit 410) may be input to a clustering algorithm (which may be executed by a target clustering unit 420). Similar inputs are provided for the other tracked targets. The clustering algorithm may cluster the targets together based on similarity of parameters, where two or more similar targets (given the values of the parameter thereof that are input) are included in a same cluster, and where a target that is not similar to any other target is added to its own separate cluster.

As described in the embodiments above, the types of parameters used may vary, depending on desired functionality. In an example, the one or more parameters comprise a Cartesian parameter comprising a Cartesian position, a velocity, or an acceleration of the target, or a combination thereof a polarization parameter comprising a radial position or a radial speed of the target, or a combination thereof; an energy measurement of the target; or a time duration during which the target is detected; or combination thereof. The Cartesian parameter includes at least one of: a Cartesian position, a velocity, or an acceleration. The polarization parameter includes at least one of: a radial position or a radial speed.

In an example, the tracking one or more parameters of the target across the plurality of point clouds may comprise tracking a change in a measured value of the target in multiple successive sensor images Additionally or alternatively, tracking one or more parameters of the target may be based, at least in part, on measurements of a parameter of the target. The measurements may correspond to a predefined number of sensor images.

According to some embodiments, a state model may be employed. For example, according to some embodiments, tracking one or more parameters of the target comprises updating a state model of the target, wherein the state model comprises an alpha-beta-gamma filter, a Kalman filter, an unscented Kalman filter, an extended Kalman filter, a converted measurements Kalman filter, an adaptive Kalman filter, a likelihood of a tracker hypothesis, or a particle filter tracker, or a combination thereof. According to some embodiments, including the target in a cluster of targets based on tracking may comprise including the target in a cluster of targets based on the one or more characteristics of the target provided by the state model, the one or more characteristics comprising a position of the target, a radial speed of the target, a gain of the target, a position change per sensor image, a rate of the position change, a radial speed change per sensor image, a rate of the radial speed change, a gain change per sensor image, a rate of the gain change, or a time duration during which the target is detected, or a combination thereof. According to some embodiments, the state model may comprise a Kalman filter, and the method may further comprise providing input to the state model, where the input comprises a position innovation, a radial speed innovation, a gain innovation, a position covariance matrix, a radial speed covariance matrix, or a gain covariance matrix, or a combination thereof. According to some embodiments, the state model may comprise an unscented Kalman filter. In such embodiments the method may further comprise providing input to the state model, the input comprising a position innovation, a radial speed innovation, a gain innovation, a position covariance matrix, a radial speed covariance matrix, a gain covariance matrix, or a set of points that represents posterior mean and covariance of the position, or a combination thereof. In some embodiments, the state model may comprise an unscented particle filter tracker. In such embodiments, the method may further comprise providing input to the state model, the input comprising a position innovation, a radial speed innovation, a gain innovation, a position covariance matrix, a radial speed covariance matrix, a gain covariance matrix, or an uncertainty distribution using weighted particles of the one or more parameters, or a combination thereof.

According to some embodiments, the tracking one or more parameters of the target across the plurality of point clouds may be performed at a first frame rate, and the including the target in the cluster of targets may be performed at a second frame rate. Additionally or alternatively, tracking the one or more parameters of the target may comprise determining a characteristic. The characteristic may comprise a position of the target, a speed of the target, a gain of the target, or a time period during which the target is detected, or a combination thereof. Additionally or alternatively, tracking the one or more parameters of the target may further comprise determining a change in the characteristic. In such embodiments, tracking one or more parameters of the target may comprise updating a state model by storing values, the values comprising a value per imaging frame of the characteristic, and a value per imaging frame of the change in characteristic. Optionally, the cluster of targets may comprise a one or more additional targets, and including the target in the cluster of targets may comprise clustering the target with the one or more additional targets based on a similarity between the stored values and corresponding values of the one or more additional targets.

According to some embodiments, the method may further comprise providing an output indicative of the detected object. The details regarding this functionality may be dependent on a device performing the operation. For example, if a processor (e.g., processor 230) or imaging sensor (e.g., radar sensor 205) is performing the functionality, providing the output may comprise providing object-detection and/or clustering information to a fusion engine (e.g., sensor fusion unit 233). Alternatively, if the functionality is performed by a fusion engine or other automotive system, providing the output may comprise providing object-detection information to one or more other automotive systems, local and/or remote devices, user interfaces (e.g., in automotive display), and/or the like.

Finally, according to some embodiments, determining the target in the point cloud may comprise determining to track a data point in the point cloud based on a parameter of the data point in the point cloud, a parameter of the data point across multiple point clouds, or both, wherein the data point corresponds to the target.

FIG. 8 as a block diagram illustrating components of an example computing device 800, according to embodiments of the present disclosure. The computing device 800 is an example of a device that includes a processor that can be programmed to perform various operations described herein above. As described with regard to FIG. 2 a radar sensor 205 may be integrated into and/or in communication with a computing device 800 (which may comprise one or more of the components illustrated in FIG. 2).

The computing device 800 includes at least a processor 802, a memory 804, a storage device 806, input/output peripherals (I/O) 808, communication peripherals 810, and an interface bus 812. The interface bus 812 is configured to communicate, transmit, and transfer data, controls, and commands among the various components of the computing device 800. Any of the memory 804 or the storage device 806 can include a secure architecture (e.g., a replay protected memory block, an EEPROM fuse, or a secure file system on a non-volatile memory portion) that stores authentication data, registration data, a shared secret, and/or a pair of asymmetric encryption keys. The memory 804 and the storage device 806 include computer-readable storage media, such as RAM, ROM, electrically erasable programmable read-only memory (EEPROM), hard drives, CD-ROMs, optical storage devices, magnetic storage devices, electronic non-volatile computer storage, for example Flash® memory, and other tangible storage media. Any of such computer-readable storage media can be configured to store instructions or program codes embodying aspects of the disclosure. The memory 804 and the storage device 806 also include computer-readable signal media. A computer-readable signal medium includes a propagated data signal with computer-readable program code embodied therein. Such a propagated signal takes any of a variety of forms including, but not limited to, electromagnetic, optical, or any combination thereof. A computer-readable signal medium includes any computer-readable medium that is not a computer-readable storage medium and that can communicate, propagate, or transport a program for use in connection with the computing device 800.

Further, the memory 804 includes an operating system, programs, and applications. The processor 802 is configured to execute the stored instructions and includes, for example, a logical processing unit, a microprocessor, a digital signal processor, and other processors. The memory 804 and/or the processor 802 can be virtualized and can be hosted within another computing device of, for example, a cloud network or a data center. The I/O peripherals 808 include user interfaces, such as a keyboard, screen (e.g., a touch screen), microphone, speaker, other input/output devices, and computing components, such as graphical processing units, serial ports, parallel ports, universal serial buses, and other input/output peripherals. The I/O peripherals 808 are connected to the processor 802 through any of the ports coupled to the interface bus 812. The communication peripherals 810 are configured to facilitate communication between the computing device 800 and other computing devices over a communications network and include, for example, a network interface controller, modem, wireless and wired interface cards, antenna, and other communication peripherals.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter, as would be readily apparent to one of ordinary skill in the art. Indeed, the methods and systems described herein may be embodied in a variety of other forms; furthermore, various omissions, substitutions, and changes in the form of the methods and systems described herein may be made without departing from the spirit of the present disclosure. The accompanying claims and their equivalents are intended to cover such forms or modifications as would fall within the scope and spirit of the present disclosure.

Unless specifically stated otherwise, it is appreciated that throughout this specification discussions utilizing terms such as “processing,” “computing,” “calculating,” “determining,” and “identifying,” or the like, refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computing devices accessing stored software that programs or configures the portable device from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements, and/or steps are in any way required for one or more examples or that one or more examples necessarily include logic for deciding, with or without author input or prompting, whether these features, elements, and/or steps are included or are to be performed in any particular example.

The terms “comprising,” “including,” “having,” and the like, are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

In view of this description embodiments may include different combinations of features. Implementation examples are described in the following numbered clauses:
Clause 1: A method of clustering targets detected by an imaging sensor in support of object detection, the method implemented on a device and comprising: determining a target in a point cloud, wherein the point cloud is generated by the imaging sensor and corresponds to a sensor image; tracking one or more parameters of the target across a plurality of point clouds, wherein the one or more parameters are indicative of one or more characteristics of the target; and including the target in a cluster of targets based on the tracking, wherein the cluster indicates a detected object.
Clause 2: The method of clause 1, wherein the imaging sensor comprises a radar sensor or a lidar sensor.
Clause 3: The method of any of clauses 1-2 further comprising providing an output indicative of the detected object.
Clause 4: The method of any of clauses 1-3 wherein the one or more parameters comprise: a Cartesian parameter comprising a Cartesian position, a velocity, or an acceleration of the target, or a combination thereof; a polarization parameter comprising a radial position or a radial speed of the target, or a combination thereof an energy measurement of the target; or a time duration during which the target is detected; or a combination thereof.
Clause 5: The method of any of clauses 1-4 wherein tracking one or more parameters of the target across the plurality of point clouds comprises tracking a change in a measured value of the target in multiple successive sensor images.
Clause 6: The method of any of clauses 1-5 wherein tracking one or more parameters of the target is based, at least in part, on measurements of a parameter of the target, wherein the measurements correspond to a predefined number of successive sensor images.
Clause 7: The method of any of clauses 1-6 wherein tracking one or more parameters of the target comprises updating a state model of the target, wherein the state model comprises: an alpha-beta-gamma filter, a Kalman filter, an unscented Kalman filter, an extended Kalman filter, a converted measurements Kalman filter, an adaptive Kalman filter, a likelihood of a tracker hypothesis, or a particle filter tracker, or a combination thereof.
Clause 8: The method of clause 7 wherein including the target in a cluster of targets based on tracking comprise including the target in a cluster of targets based on the one or more characteristics of the target provided by the state model, the one or more characteristics comprising: a position of the target, a radial speed of the target, a gain of the target, a position change per sensor image, a rate of the position change, a radial speed change per sensor image, a rate of the radial speed change, a gain change per sensor image, a rate of the gain change, or a time duration during which the target is detected, or a combination thereof.
Clause 9: The method of clause 8 wherein the state model comprises a Kalman filter, and wherein the method further comprises providing input to the state model, the input comprising: a position innovation, a radial speed innovation, a gain innovation, a position covariance matrix, a radial speed covariance matrix, or a gain covariance matrix, or a combination thereof.
Clause 10: The method of clause 8 wherein the state model comprises an unscented Kalman filter, and wherein the method further comprises providing input to the state model, the input comprising: a position innovation, a radial speed innovation, a gain innovation, a position covariance matrix, a radial speed covariance matrix, a gain covariance matrix, or a set of points that represents posterior mean and covariance of the position, or a combination thereof.
Clause 11: The method of any of clauses 1-10 wherein the state model comprises an unscented particle filter tracker, and wherein the method further comprises providing input to the state model, the input comprising: a position innovation, a radial speed innovation, a gain innovation, a position covariance matrix, a radial speed covariance matrix, a gain covariance matrix, or an uncertainty distribution using weighted particles of the one or more parameters, or a combination thereof.
Clause 12: The method of any of clauses 1-11 wherein tracking one or more parameters of the target across the plurality of point clouds is performed at a first frame rate, and wherein the including the target in the cluster of targets is performed at a second frame rate.
Clause 13: The method of any of clauses 1-12 wherein tracking the one or more parameters of the target comprises determining a characteristic, the characteristic comprising: a position of the target, a speed of the target, a gain of the target, or a time period during which the target is detected, or a combination thereof.
Clause 14: The method of clause 13 wherein tracking the one or more parameters of the target further comprises determining a change in the characteristic.
Clause 15: The method of clause 14 wherein tracking one or more parameters of the target comprises updating a state model by storing values, the values comprising a value per imaging frame of the characteristic, and a value per imaging frame of the change in characteristic.
Clause 16: The method of clause 15 wherein the cluster of targets comprises a one or more additional targets; and including the target in the cluster of targets comprises clustering the target with the one or more additional targets based on a similarity between the stored values and corresponding values of the one or more additional targets.
Clause 17: The method of any of clauses 1-16 wherein determining the target in the point cloud comprises determining to track a data point in the point cloud based on a parameter of the data point in the point cloud, a parameter of the data point across multiple point clouds, or both, wherein the data point corresponds to the target.
Clause 18: The method of any of clauses 1-17 wherein the imaging sensor further performs one or more super resolution techniques on sensor data to generate the point cloud.
Clause 19: A device for clustering targets detected by an imaging sensor in support of object detection, the device comprising: a memory; and one or more processors communicatively coupled with the memory, wherein the one or more processors are configured to: determine a target in a point cloud, wherein the point cloud is generated by the imaging sensor and corresponds to a sensor image; track one or more parameters of the target across a plurality of point clouds, wherein the one or more parameters are indicative of one or more characteristics of the target; and include the target in a cluster of targets based on the tracking, wherein the cluster indicates a detected object.
Clause 20: The device of clause 19, wherein the imaging sensor comprises a radar sensor or a lidar sensor.
Clause 21: The device of any of clauses 19-20 wherein the device further comprises the imaging sensor.
Clause 22: The device of any of clauses 19-21 wherein the device is further configured to provide an output indicative of the detected object.
Clause 23: The device of any of clauses 19-22 wherein the one or more processors, to track the one or more parameters of the target across the plurality of point clouds, are configured to track a change in a measured value of the target in multiple successive sensor images.
Clause 24: The device of any of clauses 19-23 wherein the one or more processors are configured to track the one or more parameters of the target based, at least in part, on measurements of a parameter of the target, wherein the measurements correspond to a predefined number of successive sensor images.
Clause 25: The device of any of clauses 19-24 wherein the one or more processors, to track the one or more parameters of the target across the plurality of point clouds, are configured to update a state model of the target, wherein the state model comprises: an alpha-beta-gamma filter, a Kalman filter, an unscented Kalman filter, an extended Kalman filter, a converted measurements Kalman filter, an adaptive Kalman filter, a likelihood of a tracker hypothesis, or a particle filter tracker, or a combination thereof
Clause 26: The device of clause 25 wherein the one or more processors, to include the target in a cluster of targets based on tracking, are configured to include the target in a cluster of targets based on the one or more characteristics of the target provided by the state model, the one or more characteristics comprising: a position of the target, a radial speed of the target, a gain of the target, a position change per sensor image, a rate of the position change, a radial speed change per sensor image, a rate of the radial speed change, a gain change per sensor image, a rate of the gain change, or a time duration during which the target is detected, or a combination thereof.
Clause 27: The device of any of clauses 19-26 wherein the one or more processors are configured to track one or more parameters of the target across the plurality of point clouds at a first frame rate, and wherein the one or more processors are configured to include the target in the cluster of targets at a second frame rate.
Clause 28: The device of any of clauses 19-27 wherein the one or more processors, to track the one or more parameters of the target, are configured to determine a characteristic, the characteristic comprising: a position of the target, a speed of the target, a gain of the target, or a time period during which the target is detected, or a combination thereof.
Clause 29: An apparatus for clustering targets detected by an imaging sensor in support of object detection, the apparatus comprising: means for determining a target in a point cloud, wherein the point cloud is generated by the imaging sensor and corresponds to a sensor image; means for tracking one or more parameters of the target across a plurality of point clouds, wherein the one or more parameters are indicative of one or more characteristics of the target; and means for including the target in a cluster of targets based on the tracking, wherein the cluster indicates a detected object.
Clause 30: A non-transitory computer-readable medium storing instructions for clustering targets detected by an imaging sensor in support of object detection, the instructions comprising code for: determining a target in a point cloud, wherein the point cloud is generated by the imaging sensor and corresponds to a sensor image; tracking one or more parameters of the target across a plurality of point clouds, wherein the one or more parameters are indicative of one or more characteristics of the target; and including the target in a cluster of targets based on the tracking, wherein the cluster indicates a detected object.

What is claimed is:

1. A method of clustering targets detected by an imaging sensor in support of object detection, the method implemented on a device and comprising:
determining a target in a point cloud, wherein the point cloud is generated by the imaging sensor and corresponds to a sensor image;
tracking one or more parameters of the target across a plurality of point clouds, wherein the one or more parameters are indicative of one or more characteristics of the target; and
including the target in a cluster of targets based on the tracking, wherein the cluster indicates a detected object.

2. The method of claim 1, wherein the imaging sensor comprises a radar sensor or a lidar sensor.

3. The method of claim 1, further comprising providing an output indicative of the detected object.

4. The method of claim 1, wherein the one or more parameters comprise:
a Cartesian parameter comprising a Cartesian position, a velocity, or an acceleration of the target, or a combination thereof;
a polarization parameter comprising a radial position or a radial speed of the target, or a combination thereof;
an energy measurement of the target; or
a time duration during which the target is detected; or
a combination thereof.

5. The method of claim 1, wherein tracking one or more parameters of the target across the plurality of point clouds comprises tracking a change in a measured value of the target in multiple successive sensor images.

6. The method of claim 1, wherein tracking one or more parameters of the target is based, at least in part, on measurements of a parameter of the target, wherein the measurements correspond to a predefined number of successive sensor images.

7. The method of claim 1, wherein tracking one or more parameters of the target comprises updating a state model of the target, wherein the state model comprises:
an alpha-beta-gamma filter,
a Kalman filter,
an unscented Kalman filter,
an extended Kalman filter,
a converted measurements Kalman filter,
an adaptive Kalman filter,
a likelihood of a tracker hypothesis, or
a particle filter tracker, or
a combination thereof.

8. The method of claim 7, wherein including the target in a cluster of targets based on tracking comprise including the target in a cluster of targets based on the one or more characteristics of the target provided by the state model, the one or more characteristics comprising:
a position of the target,
a radial speed of the target,
a gain of the target,
a position change per sensor image,
a rate of the position change,
a radial speed change per sensor image,
a rate of the radial speed change,
a gain change per sensor image,
a rate of the gain change, or
a time duration during which the target is detected, or
a combination thereof.

9. The method of claim 8, wherein the state model comprises a Kalman filter, and wherein the method further comprises providing input to the state model, the input comprising:
a position innovation,
a radial speed innovation,
a gain innovation,
a position covariance matrix,
a radial speed covariance matrix, or
a gain covariance matrix, or
a combination thereof.

10. The method of claim 8, wherein the state model comprises an unscented Kalman filter, and wherein the method further comprises providing input to the state model, the input comprising:
a position innovation,
a radial speed innovation,
a gain innovation,
a position covariance matrix,
a radial speed covariance matrix,
a gain covariance matrix, or
a set of points that represents posterior mean and covariance of the position, or
a combination thereof.

11. The method of claim 8, wherein the state model comprises an unscented particle filter tracker, and wherein the method further comprises providing input to the state model, the input comprising:
a position innovation,
a radial speed innovation,
a gain innovation,
a position covariance matrix,
a radial speed covariance matrix,
a gain covariance matrix, or
an uncertainty distribution using weighted particles of the one or more parameters, or
a combination thereof.

12. The method of claim 1, wherein tracking one or more parameters of the target across the plurality of point clouds is performed at a first frame rate, and wherein the including the target in the cluster of targets is performed at a second frame rate.

13. The method of claim 1, wherein tracking the one or more parameters of the target comprises determining a characteristic, the characteristic comprising:
a position of the target,
a speed of the target,
a gain of the target, or
a time period during which the target is detected, or
a combination thereof.

14. The method of claim 13, wherein tracking the one or more parameters of the target further comprises determining a change in the characteristic.

15. The method of claim 14, wherein tracking one or more parameters of the target comprises updating a state model by storing values, the values comprising a value per imaging frame of the characteristic, and a value per imaging frame of the change in characteristic.

16. The method of claim 15, wherein:
the cluster of targets comprises a one or more additional targets; and
including the target in the cluster of targets comprises clustering the target with the one or more additional targets based on a similarity between the stored values and corresponding values of the one or more additional targets.

17. The method of claim 1, wherein determining the target in the point cloud comprises determining to track a data point in the point cloud based on a parameter of the data point in the point cloud, a parameter of the data point across multiple point clouds, or both, wherein the data point corresponds to the target.

18. The method of claim 1, wherein the imaging sensor further performs one or more super resolution techniques on sensor data to generate the point cloud.

19. A device for clustering targets detected by an imaging sensor in support of object detection, the device comprising:
a memory; and
one or more processors communicatively coupled with the memory, wherein the one or more processors are configured to:
determine a target in a point cloud, wherein the point cloud is generated by the imaging sensor and corresponds to a sensor image;
track one or more parameters of the target across a plurality of point clouds, wherein the one or more parameters are indicative of one or more characteristics of the target; and
include the target in a cluster of targets based on the tracking, wherein the cluster indicates a detected object.

20. The device of claim 19, wherein the imaging sensor comprises a radar sensor or a lidar sensor.

21. The device of claim 19, wherein the device further comprises the imaging sensor.

22. The device of claim 19, wherein the device is further configured to provide an output indicative of the detected object.

23. The device of claim 19, wherein the one or more processors, to track the one or more parameters of the target across the plurality of point clouds, are configured to track a change in a measured value of the target in multiple successive sensor images.

24. The device of claim 19, wherein the one or more processors are configured to track the one or more parameters of the target based, at least in part, on measurements of a parameter of the target, wherein the measurements correspond to a predefined number of successive sensor images.

25. The device of claim 19, wherein the one or more processors, to track the one or more parameters of the target across the plurality of point clouds, are configured to update a state model of the target, wherein the state model comprises:
an alpha-beta-gamma filter,
a Kalman filter,
an unscented Kalman filter,
an extended Kalman filter,
a converted measurements Kalman filter,
an adaptive Kalman filter,
a likelihood of a tracker hypothesis, or
a particle filter tracker, or
a combination thereof.

26. The device of claim 25, wherein the one or more processors, to include the target in a cluster of targets based on tracking, are configured to include the target in a cluster of targets based on the one or more characteristics of the target provided by the state model, the one or more characteristics comprising:
a position of the target,
a radial speed of the target,
a gain of the target,
a position change per sensor image,
a rate of the position change,
a radial speed change per sensor image,
a rate of the radial speed change,
a gain change per sensor image,
a rate of the gain change, or
a time duration during which the target is detected, or
a combination thereof.

27. The device of claim 19, wherein the one or more processors are configured to track one or more parameters of the target across the plurality of point clouds at a first frame rate, and wherein the one or more processors are configured to include the target in the cluster of targets at a second frame rate.

28. The device of claim 19, wherein the one or more processors, to track the one or more parameters of the target, are configured to determine a characteristic, the characteristic comprising:
a position of the target,
a speed of the target,
a gain of the target, or
a time period during which the target is detected, or
a combination thereof.

29. An apparatus for clustering targets detected by an imaging sensor in support of object detection, the apparatus comprising:
means for determining a target in a point cloud, wherein the point cloud is generated by the imaging sensor and corresponds to a sensor image;
means for tracking one or more parameters of the target across a plurality of point clouds, wherein the one or more parameters are indicative of one or more characteristics of the target; and
means for including the target in a cluster of targets based on the tracking, wherein the cluster indicates a detected object.

30. A non-transitory computer-readable medium storing instructions for clustering targets detected by an imaging sensor in support of object detection, the instructions comprising code for:
determining a target in a point cloud, wherein the point cloud is generated by the imaging sensor and corresponds to a sensor image;
tracking one or more parameters of the target across a plurality of point clouds, wherein the one or more parameters are indicative of one or more characteristics of the target; and
including the target in a cluster of targets based on the tracking, wherein the cluster indicates a detected object.
